(19) United States
(12) Patent Application Publication
(10) Pub. No.: US 2016/0092898 A1
(43) Pub. Date: Mar. 31, 2016

(54) INTELLIGENT PRICING

(71) Applicants: Mengjiao WANG, Shanghai (CN); Wen-Syan LI, Fremont, CA (US)

(72) Inventors: Mengjiao WANG, Shanghai (CN); Wen-Syan LI, Fremont, CA (US)

(21) Appl. No.: 14/502,567

(22) Filed: Sep. 30, 2014

(51) Int. Cl. G06Q 30/02

(52) U.S. Cl. CPC G06Q 30/0206; G06Q 30/0202

(57) ABSTRACT

A computer-implemented method schedules production in a business' production facilities by seeking market orders for products of the business on a timeline commensurate with a temporal availability of production capacity. The method involves recommending a selling price for a forecasted order for products of the business, checking whether the business has available production capacity to produce the products in time to fulfill the forecasted order, and determining the business' minimum selling price for the forecasted order. The method further includes checking whether a competitor has available manufacturing capacity to compete for the forecasted order based on competitor-specific information on available manufacturing capacity, cost and minimum profit margin requirement. The competitor-specific information is derived from market intelligence data. The method includes determining the recommended selling price for the forecasted order based on the business' and the competitor's minimum selling prices, and one or more quantifiable business objectives of the business.

### BACKGROUND

A business may have manufacturing or production facilities to make products for, or to provide services, to customers. The business may sell a product or service in a market in competition with other businesses. The business may set a “selling” price for each unit of the product or service, for example, in consideration of the profit to be made. The selling price can be increased to maximize profitability for each product or service unit sold or from the market overall. Alternatively, the selling price can be lowered to defend an existing market from new competitors, to increase market share within a market, or to enter a new market. The business may benefit from advantageously lowering or increasing the selling price for the products or services sold, in response, for example, to customer or market behavior.

Setting a proper or advantageous selling price for the product or service may be an important part of successful business operations (e.g., using the business' manufacturing or production facilities). Setting a proper selling price for the product or service can be a difficult or tricky task, because a high price may result in losing customers and, conversely, a low price may result in giving up potential profit or revenue. At present, sales personnel of businesses often set the selling prices for their products or services empirically, based, for example, on anecdotal experiences and personal insight into market information. If the selling price is set too high and the business loses customers, the business' manufacturing or production capacity may be underutilized. Conversely, if the selling price is set to low and the business gains many customers, the business' manufacturing or production capacity may be overloaded and unable to meet demand.

Consideration is now being given to systems and methods for utilization of a business' manufacturing or production capacity. In particular, attention is directed to setting selling prices for products or services in a market so that demand for the business' products and services is temporally commensurate with the business' available manufacturing or production capacity.

### SUMMARY

In general aspect, a computer-implemented method is used for scheduling production in a business' production facilities to make products (e.g., goods or services). The method involves seeking market orders for the products on a timeline commensurate with a temporal availability of production capacity in the business' production facilities.

In an aspect, the method involves checking whether the business and a market place competitor have available production capacity to fulfill one or more forecasted orders for the products, identifying which combinations of the one or more forecasted orders can be fulfilled by the business and the market place competitor over a period of time, and determining which of the one or more forecasted orders are competitive orders that can be fulfilled by the business and also can be fulfilled by the competitor.

In a further aspect, the method involves using market analysis to determine competitive market selling prices that the business can use to outbid the competitor to win the competitive orders and scheduling production in the business' production facilities to make products to fulfill a winning combination of the one or more forecasted orders.

The details of one or more implementations are set forth in the accompanying drawings and the description below. Further features of the disclosed subject matter, its nature and various advantages will be more apparent from the accompanying drawings the following detailed description, and the claims.

### BRIEF DESCRIPTION OF THE DRAWINGS

FIG. 1 is a block diagram illustration of an example system for implementing pricing strategies for products or services that a business entity may offer for sale and for generating pricing recommendations for the products or services, in view of market conditions, temporal availability of production capacity, and the business objectives of the business entity, in accordance with the principles of the present disclosure.

FIG. 2 is an example graph illustrating an example regression technique that may be utilized by the system of FIG. 1 to generate a market demand forecast for the products or services, based on historical demand data, in accordance with principles of the disclosure herein.

FIG. 3 is an example graph of forecasted product orders based on data in the requests for quotes or bids to supply the product received by the business entity from customers, in accordance with principles of the disclosure herein.

FIG. 4 is an example graph which illustrates predictions or estimates of the available manufacturing or production capacities at both a competitor and the business entity over a time period during which potential or forecasted product orders may have to be fulfilled by the parties, in accordance with the in accordance with principles of the disclosure herein.

FIG. 5 is a schematic illustration of decision tree logic that may be utilized by the system of FIG. 1 to determine or recommend which combinations or sequences of potential or forecasted orders the business entity should or can compete for with the competitor based on considerations of available manufacturing capacity, in accordance with the principles of the disclosure herein.

FIG. 6 is an illustration of an example computer-implemented method for making pricing recommendations to a business entity for selling its products or services to customers in competition with a competitor, in accordance with the principles of the present disclosure.

### DETAILED DESCRIPTION

Systems and methods for making products in a business entity's (“Business'”) production facilities are described herein. The systems and methods involve winning forecasted market orders for the products on a timeline commensurate with the temporal availability of production capacity in the Business' production facilities. The market orders for the products of the Business can be generated or won by implementing competitive pricing strategies for the products taking into consideration market conditions (e.g., competitor activity), temporal availability of production capacity, and business objectives of the Business.

Existing systems and methods for implementing pricing strategies for products or services of a business entity may be based on anecdotal experiences and personal insight of sales personnel in evaluating market data.

The systems and methods (collectively “pricing solutions”) described herein, which are computer-implemented, are configured to provide logical fact-based solutions for implementing pricing strategies for products or services (collectively “products”) of the Business and for generating pricing recommendations that are competitive in the market conditions and are consistent with the business objectives of the Business.

An example computer-implemented pricing solution may integrate data from a dynamic product demand forecasting component and a dynamic market competition analysis component to support a pricing recommendation component that is configured to generate the pricing recommendations .

The dynamic product demand forecasting component, in the foregoing example computer-implemented pricing solution, may be configured to process or model demand data using machine learning algorithms or techniques (e.g., regression, neural network, decision tree, time series techniques, etc.). Use of the machine learning algorithms or techniques may enable the dynamic product demand forecasting component to process or model demand data for a business' products generated by any demand forecasting method that may be available, regardless of any particulars of the business domain in which the foregoing example computer-implemented pricing solution is utilized.

The dynamic market competition analysis component, in the foregoing example computer-implemented pricing solution, may be configured to analyze competitor data (e.g., production capacity and costs) to determine or predict a competitor's actual or likely market posture (e.g., in terms of the prices and quantities of products that the competitor may or could offer in the market).

The pricing recommendation component, in the foregoing example computer-implemented pricing solution, may be configured to generate pricing recommendations for products of the business, consistent with business objectives (e.g., profit, market share, etc.), in dynamic market conditions based on the outputs of the dynamic product demand forecasting component and the dynamic market competitor analysis component. The pricing recommendation component may also be configured to include consideration of business constraints (e.g., the dynamic production capacity that the business may have to make or deliver the products to customers in the market) when generating pricing recommendations. The pricing recommendation component may be further configured to provide business rationale or reasoning to explain the generated pricing recommendations.

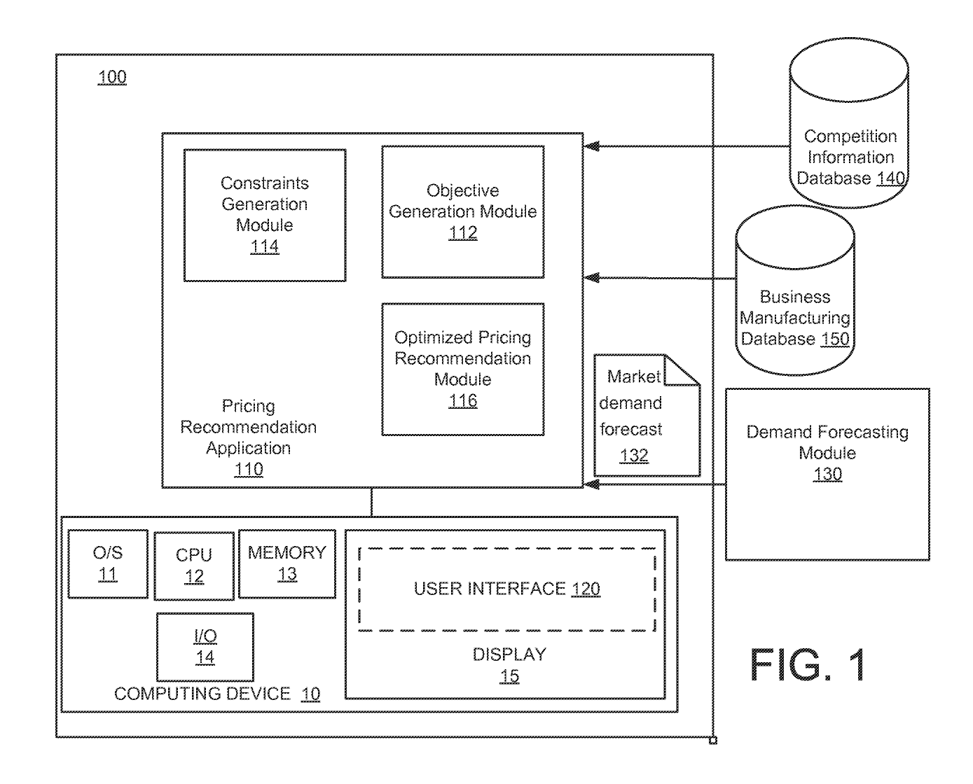

FIG. 1 shows an example system 100 for implementing pricing strategies for products that the Business may offer for sale and for generating pricing recommendations for the products, consistent with market conditions, temporal availability of production capacity, and business objectives of the Business, in accordance with the principles of the present disclosure.

System 100 may include or be coupled to a demand forecasting module 130, which may be configured to generate to forecast or predict market demand for the same or similar products as the products that the Business may offer for sale. System 100 may further include or be coupled to a competition information database 140, which may include market intelligence data on competitors who may offer the same or similar products for sale in the market in competition with the products offered by the Business. The market intelligence data on the competitors may include information such as the competitors' production capacity and costs, product quality levels, and past or predicted pricing practices or strategies used by the competitors, etc.

System 100 may further include a pricing recommendation application 110, which may be structured to generate pricing recommendations for the products of the Business, consistent with market conditions and the business objectives of the Business, by processing a market demand forecast 132 (e.g., generated by demand forecasting module 130) in conjunction with the market intelligence information on the competitors (e.g., information available from competition information database 140) and production data (e.g., production capacity and costs, etc.) related to the Business' production capabilities (e.g., available from a business manufacturing database 150).

Pricing recommendation application 110 may include a pricing recommendation module 116 that is configured to generate pricing recommendations for a particular product sale offering of the Business by processing the market demand forecasts, competitor data, and the Business's production capabilities data. Pricing recommendation module 116 may be coupled to an objectives generation module 112 and a constraint generation module 114, which may supply optimization criteria to pricing recommendation module 116 for optimizing the pricing recommendations for the particular product sale offering of the Business.

For example, objectives generation module 112 may be configured to allow selection (e.g., user selection) of one or more business objectives that the Business may have or hope to achieve with the particular sale offering of the products in the market. The business objectives may, for example, include business objectives such as preferences for maximizing revenue and/or profit, preferences for long-term deals and/or short term deals, etc. Each of the business objectives may be represented by quantifiable key performance indicators (KPI). Pricing recommendation module 116 may use the selected business objective (e.g., maximize profit) as an optimization parameter when processing the market demand forecasts and competitor data for generating the pricing recommendations. In an example implementation, pricing recommendation module 116 may be configured to generate pricing recommendations for a particular product sale offering for different business objectives, and to rank or list the generated pricing recommendations by business objectives.

Constraints generation module 114 may be configured to allow selection (e.g., user selection) of one or more quantifiable conditions or constraints that the Business may have regarding sales of their products. The one or more conditions or constraints may be policy based. For example, the Business may have a “quality” policy to only manufacture products of a high quality and to sell the high quality products at a high price, even if the Business is capable of manufacturing products of a lower quality that can be sold at a lower price. The Business may be willing to forgo its monetary business objectives (e.g., maximize revenue, profit, etc.) to uphold its quality policy, for example, to maintain a reputation or name in the market as a seller of high quality products. Other conditions or constraints (e.g., maximum plant capacity, available production capacity, delivery deadlines, etc.) may relate to manufacturing or production aspects of the Business. Pricing recommendation module 116 may use the constraints or conditions selected at constraints generation module 114, as constraint parameters when processing the market demand forecasts and competitor data for generating the pricing recommendations. In case of a delivery deadline constraint, pricing recommendation module 116 may recommend rejecting or refusing an order if the Business is unable to produce or deliver sufficient products (e.g., due to insufficient available production capacity) to meet the delivery deadline.

In system 100, pricing recommendation application 110 and other system components (e.g., demand forecasting module 130, competition information database 140) may be hosted on one or more standalone or networked physical or virtual computing machines. FIG. 1 shows, for example, pricing recommendation application 110 hosted on a computing device 10 (e.g., a desktop computer, a mainframe computer, a server, a personal computer, a mobile computing device, a laptop, a tablet, or a smart phone), which may be available to a user. Computing device 10, which includes an O/S 11, a CPU 12, a memory 13, and I/O 14, may further include or be coupled to a display 15 (including, for example, a user interface 120). Pricing recommendations generated by pricing recommendation application 110 may be presented to the user, for example, on user interface 120.

Moreover, although computer 10 is illustrated in the example of FIG. 1 as a single computer, it may be understood that computer 10 may represent two or more computers in communication with one another. Therefore, it will also be appreciated that any two or more components of system 100 may similarly be executed using some or all of the two or more computing devices in communication with one another. Conversely, it also may be appreciated that various components (e.g., demand forecasting module 130, etc.) illustrated as being external to computer 10 may actually be implemented therewith.

Pricing recommendation application 110 may be linked, for example, via Internet or intranet connections, to competitor information database 140 and demand forecasting module 130. Further, pricing recommendation application 110 may be linked to data sources on the web (e.g., worldwide and/or enterprise webs) and/or or other computer systems of the organization (e.g., e-mail systems, human resource systems, material systems, operations, etc.) that may have information relevant to the generation and implementation of the pricing recommendations generated by pricing recommendation application 110.

### Overall Market Demand Forecast/Demand Forecasting Module 130

Pricing recommendation application 110 may generate pricing recommendations for the product sale offerings of the Business by considering a forecasted market demand (e.g., market demand forecast 132) for the products. Based on economic theory, a high market demand for the products may support to high selling prices and, conversely, low market demand for the products may support only low selling prices. The forecasted market demand for the products may be obtained from any source or using any forecasting technique. In an example implementation of pricing recommendation application 110, demand forecasting module 130 may be the source of a forecasted market demand (e.g., market demand forecast 132) for the product sale offerings of the Business.

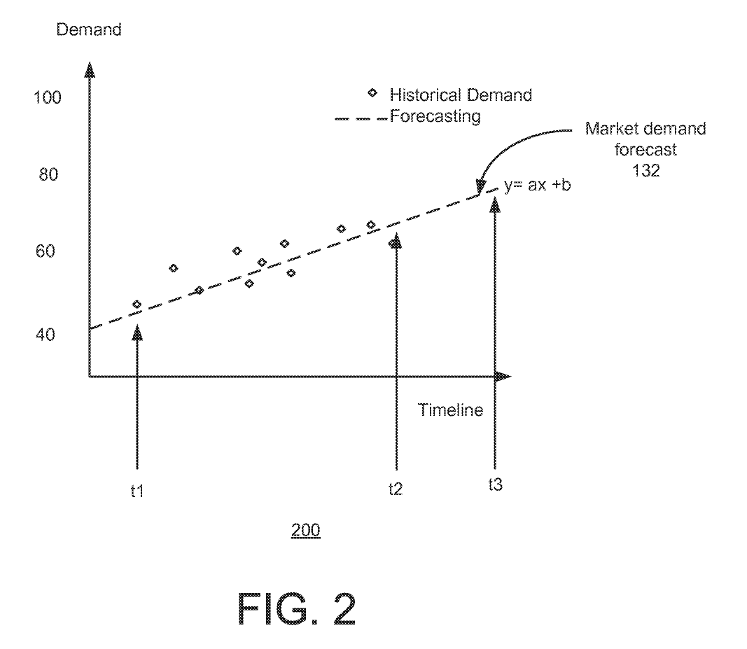

In an example implementation, product demand forecasting module 130 may be configured to process or model market demand data using machine learning algorithms or techniques (e.g., regression, neural network, decision tree, time series techniques, etc.). FIG. 2 shows, for example, a graph 200 illustrating a regression technique that may be utilized by product demand forecasting module 130 to generate market demand forecast 132 for the products based on historical demand data. In graph 200, historical demand data (shown as dots) may be distributed between times t1 and t2 along a timeline (x-axis) of the graph. Product demand forecasting module 130 may model the historical demand data as a straight line, y=ax+b, and use a linear regression techniques to fit the historical demand data to the straight line (e.g., determine fitting parameters “a” and “b”). Market demand forecast 132 (e.g., between times t2 and t3) may be then represented by the straight line, y=ax+b.

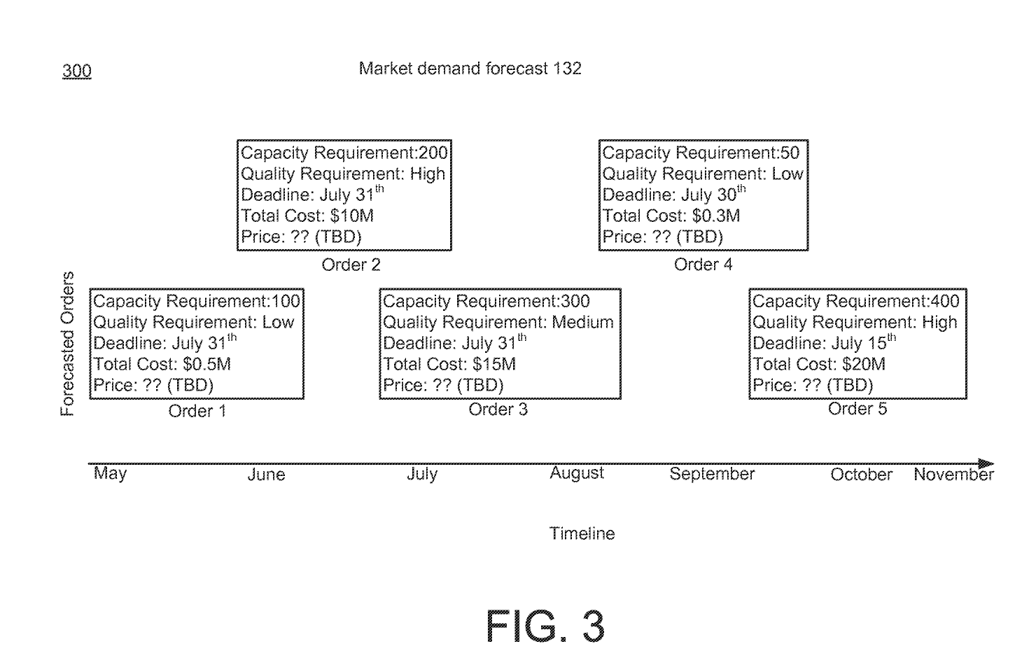

In an alternate implementation of pricing recommendation application 110, product demand forecasting module 130 may be configured to generate market demand forecast 132 as an empirically constructed demand graph. For example, some business domains or fields (e.g., high technology industries such as mobile phone manufacturing) may have a limited number of customer entities. The Business may receive requests for quotes (or bids) to supply the product from the limited number of customers. In such cases, a market demand graph (e.g., market demand forecast 132) may be empirically constructed by assembling data from the requests for quotes or bids to supply the product received from the limited number of customers. FIG. 3 shows, for example, an empirically constructed graph 300, which may be constructed based on data in the requests for quotes to supply the product received from the limited number of customers. Each request for quote may be represented by a forecasted order (e.g., forecasted orders 1-5) along a timeline (e.g., May to November) in graph 300. Each of the forecasted orders (e.g., forecasted orders 1-5) may include data on business requirements such as a capacity requirement (e.g., a production capacity requirement for manufacturing or producing the number of units of the products in the order), a quality requirement, and other data such as an estimated production cost that the Business would likely incur for manufacturing or delivering the required number of products in the order by a delivery time deadline. Graph 300 may be used as market demand forecast 132, which is input to pricing recommendation application 110 to generate pricing recommendations. Pricing recommendation application 110 may be configured to generate a pricing recommendation for each forecasted order (e.g., orders 1-5).

### Example Use Case of a Plurality of Forecasted Orders

As described previously, pricing recommendation application 110 may be used to generate selling price recommendations for products of a business by integrated analysis and processing of market demand forecasts, competitor data, and the Business's production capabilities data. For the case where the market demand forecasts include a plurality forecasted orders (e.g., Graph 300), pricing recommendation application 110 may be configured to generate pricing recommendations order-by-order.

Order-by-order operations of system 100/pricing recommendation application 110 are further described herein with reference to an example use case in which market demand forecast 132 may include three forecasted orders (e.g., orders 1-3) as shown, for example, in TABLE 1 below.

TABLE 1

| | Order 1 | Order 2 | Order 3 |
|---|---|---|---|
| Total Capacity | 6000 Units | 3000 Units | 4500 Units |
| Requirement | | | |
| Quality | High | High | Low |
| Requirement | | | |
| Start Date | 1st July | 1st July | 1st August |
| Due Date | 30th July | 15th July | 30th August |
| Total Material Cost | $10M | $5M | $7M |

For the example use case of TABLE 1, it may be assumed that there is only one competitor to the Business in the market. Further, it may be assumed that a user-selected business objective of the Business for the example use case is to maximize revenue and that the pricing recommendations generated by pricing recommendation application 110 may include recommendations to refuse orders.

The forecasted orders (e.g., orders 1-3) as shown in TABLE 1, may describe requirements (e.g., Total Capacity Requirement, Quality Requirement, Start Date, Due Date and Total Material Cost, etc.) on the Business' product manufacturing or delivery facilities for fulfilling each order. TABLE 1, for example, shows Order 1 has a Total (manufacturing) Capacity Requirement=6000 units, a Quality Requirement=High, a Start Date=1^{st} July, a Due Date=30^{st} July and a Total Material Cost=$10M; Order 2 has a Total (manufacturing) Capacity Requirement=3000 units, a Quality Requirement=High, a Start Date=1^{st} July, a Due Date=15^{th} July and a Total Material Cost=$5M; and Order 3 has a Total (manufacturing) Capacity Requirement=4500 units, a Quality Requirement=low, a Start Date=1^{st} August, a Due Date=30^{th} August and a Total Material Cost=$5M.

For generating pricing recommendations for orders 1-3 shown in TABLE 1, pricing recommendation application 110/pricing recommendation module 116 may pull up information on competitors' capabilities (e.g., a single competitor in the example use case) from competition information database 140 (FIG. 1) and compare or analyze the competitor's capabilities relative to the Business' capabilities for product manufacturing or delivery (obtained, for example, from business manufacturing database 150). The comparative analysis, as shown for example in TABLE 2, may include comparison of parameters such as total manufacturing capacity, quality level, operation cost, and expected profit margin, etc.

TABLE 2

| | Competitor | Business |
|---|---|---|
| Total Capacity | 500 | 700 |
| Quality Level | High | High |
| Operation Cost | $500 | $450 |
| | (per capacity unit) | (per capacity unit) |
| Expected Profit Margin | 20% | 20% |

TABLE 2 shows that the competitor, for example, has a total manufacturing capacity=500 units, a quality level=high, an operation cost=$500/per unit, and an expected profit margin=20%. The comparable numbers for the Business are shown in TABLE 2 to be, for example, total manufacturing capacity=700 units, a quality level=high, an operation cost=$450/per unit, and an expected profit margin=20%.

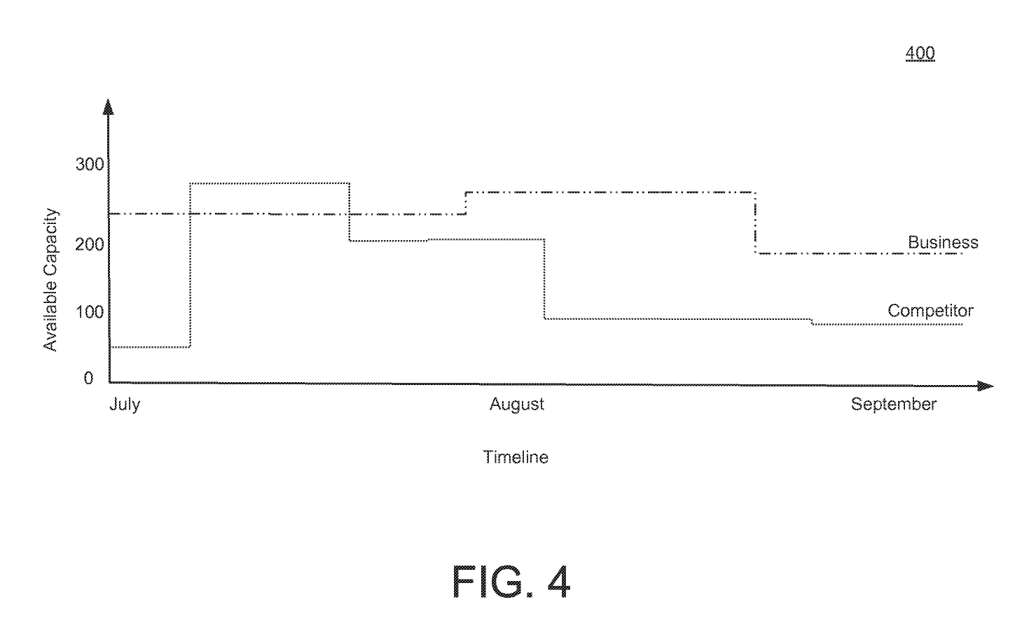

Pricing recommendation module 116 in pricing recommendation application 110 may further include algorithms to analyze data (e.g., data available in competition information database 140 and business manufacturing database 150) to compare predictions or estimates of available manufacturing capacities at both the competitor and the Business over a time period (e.g., a time period over which production or manufacturing may have to carried out to fulfill orders 1-3). FIG. 4 is an example graph which illustrates the predictions or estimates of the available manufacturing capacities of both the competitor and the Business over a time period (e.g., July to September) during which orders 1-3 may have to be performed or fulfilled by the parties.

To generate pricing recommendations for orders 1-3 (which may include recommendations to accept or reject an order), pricing recommendation module 116 may include processes for a “capacity check” to determine whether the Business and the competitor have sufficient available manufacturing capacity to fulfill various combinations or sequences of the forecasted orders (e.g., orders 1-3) in a timely manner (e.g., by the due dates 30^{th} July, 15^{th} July, and 30^{th} August, respectively as shown in TABLE 1). The results of the capacity checks by pricing recommendation module 116 may be described herein, for example, with reference to example truth TABLES 3-5 below.

TABLE 3 shows an example truth table representing results of the capacity check processes that may be utilized by pricing recommendation module 116 to check whether the estimated available manufacturing capacity (FIG. 4) of the Business is sufficient to fulfill various combinations of orders 1-3 in a timely manner.

TABLE 3

| Order 1 | Order 2 | Order 3 | Capacity Check |
|---|---|---|---|
| 0 | 0 | 1 | YES |
| 0 | 1 | 0 | YES |
| 0 | 1 | 1 | YES |
| 1 | 0 | 0 | YES |
| 1 | 0 | 1 | YES |
| 1 | 1 | 0 | NO |
| 1 | 1 | 1 | NO |

In TABLE 3, a value of “1” (e.g., under the columns headings Order 1, Order 2 and Order 3) may represent that the order is accepted, and a value “0” may represent that the order is not accepted by the Business. Each row of TABLE 3 may correspond to different respective combination of orders that are accepted and orders that are not accepted by the Business. Thus, for example, the first row in TABLE 3 which shows “0” values for all three orders (e.g., orders 1-3) corresponds to the combination of all three orders not being accepted. The last row which shows “1” values for all three orders (e.g., orders 1-3) corresponds to the combination of all three orders being accepted. The penultimate row, which shows “1” values for orders 1 and 2 and a “0” value for order 3, corresponds to the combination in which orders 1 and 2 are accepted and order 3 is not accepted.

The right most column (e.g., under the column heading Capacity Check) in TABLE 3 (e.g., with field values “YES” of “NO”) may represent a determination by pricing recommendation module 116 whether the Business has sufficient available manufacturing capacity (FIG. 4) to fulfill the various combinations of orders 1-3 in a timely manner. For example, the last row in TABLE 3 (corresponding to the combination of all three orders 1-3 being accepted by the Business) is marked with a “NO” for Capacity Check indicating a determination by pricing recommendation module 116 that the Business does not have sufficient available manufacturing capacity to fulfill the combination of all three orders 1-3 if accepted by the Business. Similarly, the penultimate row in TABLE 3 (corresponding to the combination of orders 1 and 2 being accepted by the Business and order 3 being not accepted by the Business) is marked with a “NO” for Capacity Check indicating a determination by pricing recommendation module 116 that the Business does not have sufficient available manufacturing capacity to fulfill the combination of accepted orders 1 and 2.

Pricing recommendation module 116 may be configured to remove from further consideration combinations of orders which fail the capacity check (i.e. combinations of orders for which there is insufficient available manufacturing capacity) and to evaluate only those combinations of orders which pass the capacity check (i.e., combinations of orders for which there is sufficient available manufacturing capacity) for generating pricing recommendations. TABLE 4 shows a simplified version of TABLE 3 from which rows (e.g., the last and penultimate rows) corresponding to combinations of orders that fail the capacity check are removed and only rows corresponding to combinations of orders for which pass the capacity check are retained.

TABLE 4

| Order 1 | Order 2 | Order 3 | Capacity Check |
|---|---|---|---|
| 0 | 0 | 1 | YES |
| 0 | 1 | 0 | YES |
| 0 | 1 | 1 | YES |
| 1 | 0 | 0 | YES |
| 1 | 0 | 1 | YES |

As noted previously, pricing recommendation module 116 may make pricing recommendations based on a comparison of the Business's capabilities with the competitor's capabilities to fulfill the forecasted orders. TABLE 5 is an example truth table representing results of the capacity check processes utilized by pricing recommendation module 116 to check whether the estimated available manufacturing capacity (FIG. 4) of the competitor is sufficient to fulfill various combinations of orders 1-3, which may be accepted by the competitor, in a timely manner. As in TABLE 4, rows representing combinations of orders (e.g., orders 1-3) that have failed the capacity check are not shown in TABLE 5.

TABLE 5

| Order 1 | Order 2 | Order 3 | Capacity Check |
|---|---|---|---|
| 0 | 1 | 0 | YES |
| 1 | 0 | 0 | YES |

As shown in TABLE 5, pricing recommendation module 116 using its capacity check processes may determine, for example, that the competitor may have sufficient available manufacturing capacity only to accept and fulfill only order 1 or order 2 from the forecasted orders (e.g., orders 1-3) shown in TABLE 1.

Pricing recommendation module 116 may use gaming algorithms and decision tree logic to generate pricing recommendations for the forecasted orders (e.g., orders 1-3) for the Business to compete with the competitor. The pricing recommendations may include recommendations for which forecasted orders the Business could accept or compete for and which orders the Business should forgo or not compete for with the competitor. The gaming algorithms and decision tree logic may be applied to the forecasted orders (e.g., orders 1-3) taking into account the results of the capacity check processes (e.g., as shown TABLES 4 and 5) and the business objectives or other quantifiable KPI of the Business.

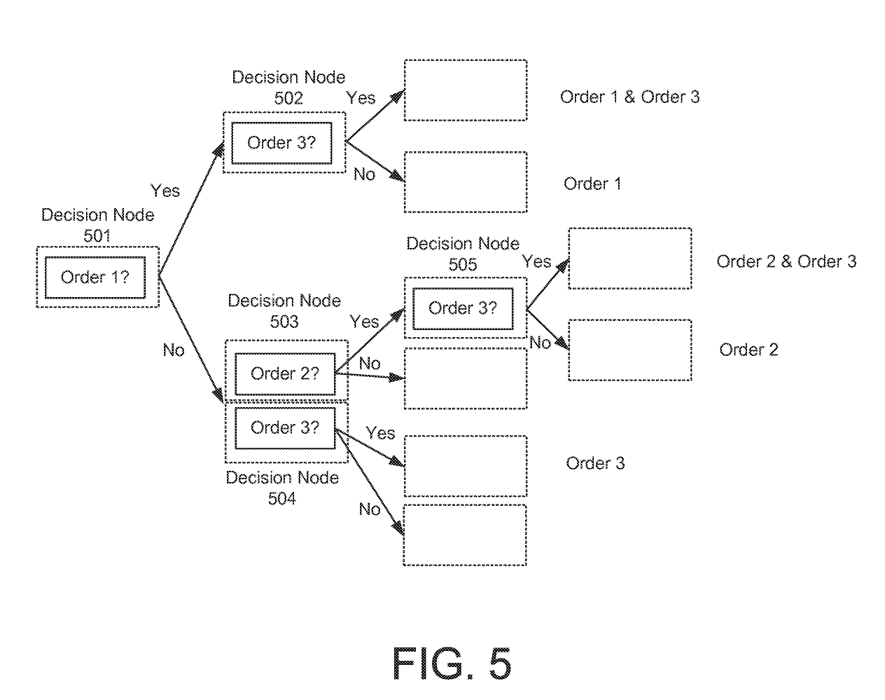

FIG. 5 schematically shows an example decision tree 500 illustrating the decision tree logic that may be utilized by pricing recommendation module 116 in the foregoing use case (of TABLE 1) to determine or recommend which combinations or sequence of forecasted orders (e.g., order 1-3) the Business should or can compete for with the competitor based on the previous capacity check results.

As shown in FIG. 5, pricing recommendation module 116 may begin, for example, by determining, at decision node 501, whether the Business should compete for order 1 (TABLE 1) based on the previous capacity check results (e.g., TABLE 4). At decision node 501, pricing recommendation module 116 may confirm that the Business can compete for order 1 based on the previous capacity check results (e.g., TABLE 4) and also determine that the Business then cannot compete for order 2 because the earlier capacity check processes may have indicated that the Business lacks sufficient available manufacturing capacity to fulfill both orders 1 and order 2 (TABLE 4). Pricing recommendation module 116 may then consider the remaining forecasted order (e.g., order 3), and at decision node 502, determine whether the Business can compete only for order 1 or for both order 1 and order 3. Pricing recommendation module 116 may determine the Business can compete for order 1 alone or compete for the combination of order 1 and order 3, based on the previous capacity check results (e.g., TABLE 4).

Pricing recommendation module 116 may consider further combinations or sequences of the orders, for example, if at decision node 501 it had determined that the Business should not compete for order 1 and to also cover a situation that even if the Business competed for order 1, the Business could lose order 1 to the competitor. Accordingly, pricing recommendation module 116 may consider whether the Business should compete for orders 2 and/or order 3 (TABLE 1) to cover both situations i.e. having not competed for order 1, or having competed for order 1 losing the order to the competitor.

For example, at decision node 503, pricing recommendation module 116 may determine whether the Business can compete for order 2 alone and at decision node 504, determine whether the Business can compete for order 3 alone, based on the previous capacity check results (e.g., TABLE 4). If the Business can compete for order 2, pricing recommendation module 116 may, at decision node 505, determine whether the Business can further compete for order 3 also without being constrained by available manufacturing capacity.

A result of decision tree 500 in the foregoing use case (as discussed with reference to TABLE 4 before) may be a determination by pricing recommendation module 116 that the Business could compete for either order 1 only, order 2 only, order 3 only, a combination of order 1 and order 3, or a combination of order 2 and order 3, consistent with the Business' available manufacturing capacity. (TABLE 4).

A similar utilization of the decision tree logic by pricing recommendation module 116 may result in a determination that the competitor could compete only for orders 1 and 2, but not for order 3, because of the competitor's limited availability manufacturing capacity (e.g., TABLE 5). Thus, pricing recommendation module 116 may determine that the Business may likely face competition for orders 1 and 2 only, but will not face competition of order 3.

Next, pricing recommendation module 116 may, for example, compute minimum selling prices for the forecasted orders (e.g., orders 1 and 2) for which the Business may be in competition with the competitor. For each forecasted order (e.g., orders 1 and 2) in competition, pricing recommendation module 116 may compute or estimate the minimum selling prices for both the Business and the competitor. The minimum selling prices computed by pricing recommendation module 116 for the Business and the competitor may be based on the Business' and the competitor's r respective manufacturing or production costs (e.g., material costs of $450/per unit and $500/per unit, respectively, as shown in TABLE 2). The minimum selling prices may be further constrained by business principles or constraints of the Business and the competitor. An example constraint may be that the selling prices must include at least the expected profit margin of 20% (TABLE 2). Pricing recommendation module 116 may, for example, use quantitative constraint functions (which may be generated by constraints generation module 114 (FIG. 1)) in the computation of the minimum selling prices.

TABLE 6 shows example minimum selling prices that may be computed by pricing recommendation module 116 in the foregoing use case for orders 1 and 2 for both the Business and the competitor.

TABLE 6
(Minimum Selling Prices)

| | Competitor | Business |
|---|---|---|
| Order 1 | $15.6M | $15.24M |
| Order 2 | $7.8M | $7.62M |

As shown in TABLE 6, for both orders 1 and 2, the minimum selling prices (e.g., $15.24M and $7.62M, respectively) of the Business are lower and more competitive than the minimum selling prices (e.g., $15.6M and $7.8M, respectively) of the competitor. Thus, pricing recommendation module 116 could, for example, recommend that the Business use the minimum selling prices (e.g., $15.24M and $7.62M, respectively) for orders 1 and 2 if the business objectives were to gain or retain market share or to gain market entry. However, the assumption (noted previously) in the foregoing use case of TABLE 1, is that the user-selected business objective is to maximize revenue. Accordingly, pricing recommendation module 116 may generate a recommendation that the Business set selling prices for the forecasted orders 1 and 2 to be higher than the Business' minimum selling prices (shown in TABLE 6) to maximize revenue, but still lower than the competitor's minimum selling prices (shown in TABLE 6) to avoid losing the orders in competition to the competitor. Pricing recommendation module 116 may, for example, recommend that the Business set a competitive selling price for order 1 at greater than $15.24M (the Business' minimum selling price) to maximize revenue but yet less than $15.6M (the Competitor's minimum selling price) so as to not lose the order to the competitor.

A computer-implemented solution may be utilized for scheduling production in a business entity's (“Business'”) production facilities, in accordance with the principles of the disclosure herein. The solution may involve implementing competitive product pricing strategies to forecast and win market orders for the products on a timeline commensurate with the temporal availability of production capacity in the Business' production facilities. The computer-implemented solution may involve providing selling price recommendations to the Business for selling its products, which take into consideration market conditions (e.g., competitor activity), temporal availability of production capacity, and business objectives of the Business.

The systems and techniques described throughout this document may result in a technical improvement in the timely production of products to meet and win market orders. Also, a technical effect realized with the systems and techniques described in this document an improved ability of a business to sell more products compared to competitors including using results of the systems and techniques to change production and/or pricing of products relative to other competitors in the market.

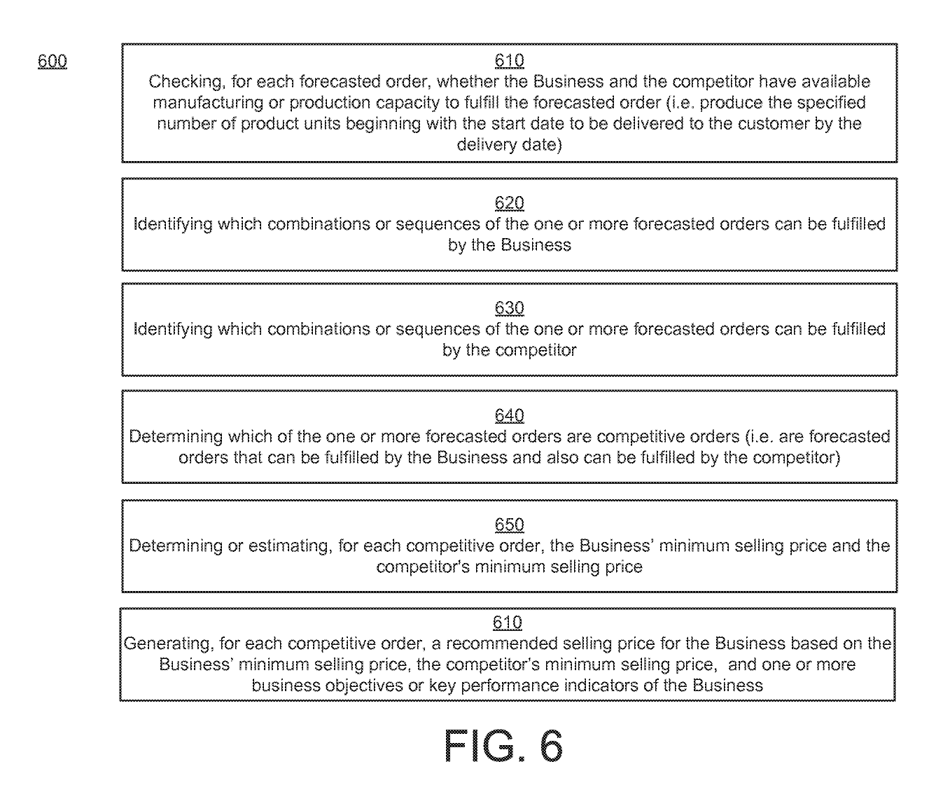

FIG. 6 shows an example computer-implemented method 600 for making pricing recommendations to the Business for selling its products or services (“products”) to customers in competition with a competitor in a market, in accordance with the principles of the present disclosure. The Business and the competitors may have respective facilities with “manufacturing” or production capacity to manufacture or create the products or services. Method 600 may involve using market intelligence to collect “competition information” including data to determine or estimate the competitor's manufacturing capacities, business objectives or constraints, and selling practices.

The pricing recommendations made using method 600 may be for one or more forecasted customer orders for the products. Each forecasted order may be for a specified number of product units to be produced and delivered to a customer by a delivery date beginning with a start date.

Method 600 may include checking, for each forecasted order, whether the Business and the competitor have available manufacturing capacity to fulfill the forecasted order (i.e. produce the specified number of product units beginning with the start date to be delivered to the customer by the delivery date) (610). Method 600 may further include identifying which combinations or sequences of the one or more forecasted orders can be fulfilled by the Business (620), identifying which combinations or sequences of the one or more forecasted orders can be fulfilled by the competitor (630), and determining which of the one or more forecasted orders are competitive orders (i.e. are forecasted orders that can be fulfilled by the Business and also can be fulfilled by the competitor) (640).

Method 600 may include determining or estimating, for each competitive order, the Business' minimum selling price and the competitor's minimum selling price (650). The Business' minimum selling price and the competitor's minimum selling price for the competitive order may be determined or estimated based on Business-specific and competitor-specific information on costs (e.g., manufacturing costs, delivery costs) and constraints such as minimum profit margin requirements, etc.

Method 600 may further include generating, for each competitive order, a recommended selling price for the competitive order based on the Business' minimum selling price for the Business, the competitor's minimum selling price, and one or more business objectives or key performance indicators of the Business (660). The business objectives or key performance indicators (e.g., profit margin, revenue, market share, product quality metric, etc.) may be a quantifiable quantity. The quantifiable quantity may be a quantity which can be described by a function. The recommended selling price for the Business may be a recommended selling price range (e.g., minimum selling price for the Business≦recommended selling price≦minimum selling price for the competitor). The Business may use the recommended selling price for the competitive order to outbid the competitor and win the competitive order from the customer.

In an implementation of method 600, generating, for each competitive order, the recommended selling price, which the Business could use to outbid the competition, may include generating the recommended selling price based on the Business' and the competitor's computed minimum selling prices for a plurality of competitive orders and one or more business objectives or key performance indicators of the Business (e.g., total revenue, total average profit, market share, or market entry, etc.) that may be applicable over a time period of the plurality of competitive orders.

The Business may use the forecasted orders (that it expects to get or win based on the recommended selling prices generated by method 600) to schedule and make products in its production facilities to satisfy the forecasted orders.

Method 600 may be performed or implemented using, for example, system 100 (FIG. 1).

The various systems and techniques described herein may be implemented in digital electronic circuitry, or in computer hardware, firmware, or in combinations of them. The various techniques may implemented as a computer program product, i.e., a computer program tangibly embodied in a machine readable storage device, for execution by, or to control the operation of, data processing apparatus, e.g., a programmable processor, a computer, or multiple computers.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magnetooptical disks, or optical disks. Information carriers suitable for embodying computer program instructions and data include all forms of nonvolatile memory, including by way of example semiconductor memory devices, e.g., EPROM, EEPROM, and flash memory devices; magnetic disks, e.g., internal hard disks or removable disks; magnetooptical disks; and CDROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a backend component, e.g., as a data server, or that includes a middleware component, e.g., an application server, or that includes a frontend component, e.g., a client computer having a graphical user interface or a Web browser through which a user can interact with an implementation, or any combination of such backend, middleware, or frontend components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the embodiments.

What is claimed is:

1. A computer-implemented method for utilizing a business' production facilities by seeking market orders for products of the business on a timeline commensurate with a temporal availability of production capacity in the business' production facilities, the method comprising:
identifying one or more forecasted orders for products of a business over a period of time;
checking, for each forecasted order, whether the business and a competitor have available production capacity to fulfill the forecasted order;
identifying which combinations of the one or more forecasted orders can be fulfilled by the business over the period of time;
identifying which combinations of the one or more forecasted orders can be fulfilled by the competitor over the period of time; and
determining which of the one or more forecasted orders are competitive orders that can be fulfilled by the business and also can be fulfilled by the competitor.

2. The method of claim 1, wherein identifying which combinations of the one or more forecasted orders can be fulfilled by the business over the period of time includes determining whether the business has sufficient available production capacity to make products to fulfill a forecasted order.

3. The method of claim 1, wherein identifying which combinations of the one or more forecasted orders can be fulfilled by the competitor over the period of time includes determining whether the competitor has sufficient available production capacity to make products to fulfill a forecasted order, and wherein information on the competitor's available production capacity is derived from market intelligence data.

4. The method of claim 1, wherein identifying which combinations of the one or more forecasted orders can be fulfilled by the business over the period of time and identifying which combinations of the one or more forecasted orders can be fulfilled by the competitor over the period of time includes using decision tree logic to determine which sequences of the one or more forecasted orders can be fulfilled by the business and the competitor, respectively.

5. The method of claim 1, further comprising determining which of the one or more forecasted orders are competitive orders that can be fulfilled by the business and also can be fulfilled by the competitor.

6. The method of claim 5 further comprising:
determining the business' minimum selling price for a competitive order based on business-specific information including the business' production costs and expected minimum profit; and
estimating the competitor's minimum selling price for the competitive order based on competitor-specific information including the competitor's production costs and expected minimum profit,
wherein the competitor-specific information is derived from market intelligence data.

7. The method of claim 6 further comprising, generating a recommended selling price for the competitive order, based on the business' minimum selling price, the competitor's minimum selling price, and one or more business objectives or key performance indicators of the business.

8. The method of claim 6, wherein the recommended selling price for the competitive order is a recommended selling price range.

9. A computer system for scheduling production in a business' production facilities by seeking market orders for products of the business on a timeline commensurate with a temporal availability of production capacity in the business' production facilities, the computer system including a memory and a semiconductor-based processor, the memory and the processor forming one or more logic circuits configured to:
identify one or more forecasted orders for products of a business over a period of time;
check, for each forecasted order, whether the business and a competitor each have available production capacity to fulfill the forecasted order;
identify which combinations of the one or more forecasted orders can be fulfilled by the business over the period of time;
identify which combinations of the one or more forecasted orders can be fulfilled by the competitor over the period of time; and
determine which of the one or more forecasted orders are competitive orders that can be fulfilled by the business and also can be fulfilled by the competitor.

10. The computer system of claim 9, wherein the logic circuits are configured to identify which combinations of the one or more forecasted orders can be fulfilled by the business over the period of time by determining whether the business has sufficient available production capacity to make products to fulfill a forecasted order.

11. The computer system of claim 9, wherein the logic circuits are configured to identify which combinations of the one or more forecasted orders can be fulfilled by the competitor over the period of time by determining whether the competitor has sufficient available production capacity to make products to fulfill a forecasted order, and wherein information on the competitor's available production capacity is derived from market intelligence data.

12. The computer system of claim 9, wherein the logic circuits are configured to identify which combinations of the one or more forecasted orders can be fulfilled by the business over the period of time and identify which combinations of the one or more forecasted orders can be fulfilled by the competitor over the period of time by using decision tree logic to determine which sequences of the one or more forecasted orders can be fulfilled by the business and the competitor, respectively.

13. The computer system of claim 9, wherein the logic circuits are further configured to determine which of the one or more forecasted orders are competitive orders that can be fulfilled by the business and also can be fulfilled by the competitor.

14. The computer system of claim 13, wherein the logic circuits are further configured to:
determine the business' minimum selling price for a competitive order based on business-specific information including the business' production costs and expected minimum profit; and
estimate the competitor's minimum selling price for the competitive order based on competitor-specific information including the competitor's production costs and expected minimum profit,
wherein the competitor-specific information is derived from market intelligence data.

15. The computer system of claim 13, wherein the logic circuits are further configured to generate a recommended selling price for the competitive order, based on the business' minimum selling price, the competitor's minimum selling price, and one or more business objectives or key performance indicators of the business.

16. The computer system of claim 15, wherein the recommended selling price for the competitive order is a recommended selling price range.

17. A non-transitory computer readable storage medium having instructions stored thereon, including instructions which, when executed by a microprocessor, cause a computer system to schedule production in a business' production facilities by seeking market orders for products of the business on a timeline commensurate with a temporal availability of production capacity in the business' production facilities, the instructions causing the computer system to:
identify a forecasted order for products of a business;
check whether the business has available manufacturing capacity to produce the products in time to fulfill the forecasted order and determining the business' minimum selling price for the forecasted order, based on business-specific information on available manufacturing capacity, cost and minimum profit margin requirement; and
check whether a competitor has available manufacturing capacity to produce the products in time to fulfill the forecasted order and determining the competitor's minimum selling price for the forecasted order, based on competitor-specific information on available manufacturing capacity, cost and minimum profit margin requirement,
wherein the competitor-specific information is derived from market intelligence data.

18. The non-transitory computer readable storage medium of claim 17 further comprising, generating a recommended selling price for the forecasted order based on the business' minimum selling price and a quantifiable business objective or key performance index of the business.

19. The non-transitory computer readable storage medium of claim 18, wherein the quantifiable business objective or key performance index relates to one of revenue, profit, market share, and a product quality metric.

20. The non-transitory computer readable storage medium of claim 18, wherein the recommended selling price is a recommended selling price range.
